(19) United States
(12) Patent Application Publication
(10) Pub. No.: US 2025/0132515 A1
(43) Pub. Date: Apr. 24, 2025

(54) COMPLIANT ELECTRICAL CONNECTOR HAVING A RESILIENT CONNECTOR SUPPORT INTEGRATED INTO A BATTERY DISCONNECT UNIT

(71) Applicant: GM Global Technology Operations LLC, Detroit, MI (US)

(72) Inventors: Timothy Glenn Ross, Washington, MI (US); Nicholas Compton, Freeland, MI (US); Xianfeng Yan, Clawson, MI (US); William Yu Chen, Troy, MI (US); Simon James Hammond Trask, Royal Oak, MI (US); Igor M. Kan, White Lake, MI (US)

(21) Appl. No.: 18/490,068

(22) Filed: Oct. 19, 2023

(51) Int. Cl. H01R 13/24; B60L 50/64; H01R 13/639

(52) U.S. Cl. CPC H01R 13/2414; B60L 50/64; H01R 13/639; H01R 2201/26

(57) ABSTRACT

A system, in accordance with a non-limiting example, includes a first member including a first electrical connector and a second member including a second electrical connector. The first member includes a rigid base and a resilient connector support coupled to the rigid base. The first electrical connector is being mounted to the resilient connector support.

### INTRODUCTION

The subject disclosure relates to the art of electrical connectors and, more particularly, to a compliant electrical connector having a resilient connector support integrated into a battery disconnect unit (BDU).

In certain systems, connections are made by sliding a first component supporting a first connector portion toward a second component having a second connector portion. When brought together, the first connector portion and the second connector portion are engaged. While effective, tolerances between the first component and the second component are relaxed. Relaxing the tolerances accommodates any misalignments that may exist between the first connector portion and the second connector portion without negatively affecting the connection. The relaxed tolerances are particularly useful when creating multiple connections, and/or connections arranged in different planes.

While relaxed tolerances are helpful when making electrical connections, they are not suitable for every application. Certain applications, particularly where space is at a premium, require tighter tolerances. Maintaining tighter tolerances when manufacturing components increases component complexity, manufacturing time, and assembly time. Accordingly, it is desirable to provide a system for accommodating connections without having to tighten component tolerances.

### SUMMARY

A system, in accordance with a non-limiting example, includes a first member including a first electrical connector and a second member including a second electrical connector. The first member includes a rigid base and a resilient connector support coupled to the rigid base. The first electrical connector is being mounted to the resilient connector support.

In addition to one or more of the features described herein the first electrical connector and the second electrical connector define a connection axis, wherein the resilient connector support is selectively shiftable relative to the connection axis when forming an electrical connection.

In addition to one or more of the features described herein the first electrical connector is shiftable along an axis that is substantially parallel with the connection axis when forming the electrical connection.

In addition to one or more of the features described herein the first electrical connector is shiftable along an axis that is angled relative to the connection axis when forming the electrical connection.

In addition to one or more of the features described herein the first electrical connector is shiftable along a first axis and along a second axis when forming the electrical connection.

In addition to one or more of the features described herein one of the first axis and the second axis is substantially parallel with the connection axis.

In addition to one or more of the features described herein the resilient connector support is formed from a non-electrically conductive flexible material.

In addition to one or more of the features described herein the non-electrically conductive flexible material is one of an elastomeric material, a rubber material, a silicone material, and combinations thereof.

In addition to one or more of the features described herein the first component is a battery disconnect unit and the second component is a battery assembly.

In addition to one or more of the features described herein the first electrical connector includes a first connector member arranged in a first plane, a second connector member arranged in a second plane distinct from the first plane, and a third connector member arranged in a third plane, and the second electrical connector includes a first connector element arranged in the first plane, a second connector element arranged in the second plane, and a third connector element arranged in the third plane.

A vehicle includes a body defining a passenger compartment, a drive unit supported in the body and a rechargeable energy storage system (RESS) connected to the drive unit, the RESS including a battery disconnect unit having a first electrical connector and a battery assembly including a second electrical connector. The first member includes a rigid base and a resilient connector support coupled to the rigid base. The first electrical connector is mounted to the resilient connector support.

In addition to one or more of the features described herein the first electrical connector and the second electrical connector define a connection axis, wherein the resilient connector support is selectively shiftable relative to the connection axis when forming an electrical connection.

In addition to one or more of the features described herein the first electrical connector is shiftable along an axis that is substantially parallel with the connection axis when forming the electrical connection.

In addition to one or more of the features described herein the first electrical connector is shiftable along an axis that is angled relative to the connection axis when forming the electrical connection.

In addition to one or more of the features described herein the first electrical connector is shiftable along a first axis and along a second axis when forming the electrical connection.

In addition to one or more of the features described herein one of the first axis and the second axis is substantially parallel with the connection axis.

In addition to one or more of the features described herein the resilient connector support is formed from a non-electrically conductive flexible material.

In addition to one or more of the features described herein the non-electrically conductive flexible material is one of an elastomeric material, a rubber material, a silicone material, and combinations thereof.

In addition to one or more of the features described herein the first electrical connector includes a first connector member arranged in a first plane, a second connector member arranged in a second plane distinct from the first plane, and a third connector member arranged in a third plane, and the second electrical connector includes a first connector element arranged in the first plane, a second connector element arranged in the second plane, and a third connector element arranged in the third plane.

In addition to one or more of the features described herein the resilient connector support is bonded to the rigid base.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery assembly having a battery disconnect unit (BDU) provided with a compliant electrical connector including a resilient connector support, in accordance with a non-limiting example;

FIG. 2 is a view of a battery assembly including the BDU having a compliant electrical connector including a resilient connector support, in accordance with a non-limiting example;

FIG. 3 is a front left perspective view of the BDU of FIG. 2, in accordance with a non-limiting example;

FIG. 4 is a top view of the BDU of FIG. 3, in accordance with a non-limiting example;

FIG. 5 is a cross-sectional side view of an electrical connector of the BDU of FIG. 4 including a rigid base and a resilient connector support taken through the line 5-5, in accordance with a non-limiting example;

FIG. 6 is a front view of the electrical connector of FIG. 5, in accordance with a non-limiting example;

FIG. 7 is a cross-sectional side view of the electrical connector of FIG. 5 showing the resilient connector support shifting along a connector axis, in accordance with a non-limiting example;

FIG. 8 is a cross-sectional side view of the electrical connector of FIG. 5 showing the resilient connector support shifting at an angle relative to the connector axis, in accordance with a non-limiting example;

FIG. 9 is a cross-sectional side view of a battery assembly connecting to the BDU, in accordance with a non-limiting example;

FIG. 10 is a cross-sectional side view of a battery assembly connecting to the BDU, in accordance with another non-limiting example;

FIG. 11 is a cross-sectional side view of a battery assembly connecting to the BDU, in accordance with yet another non-limiting example; and

FIG. 12 is a front right perspective view of a BDU including a resilient connector support, in accordance with another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

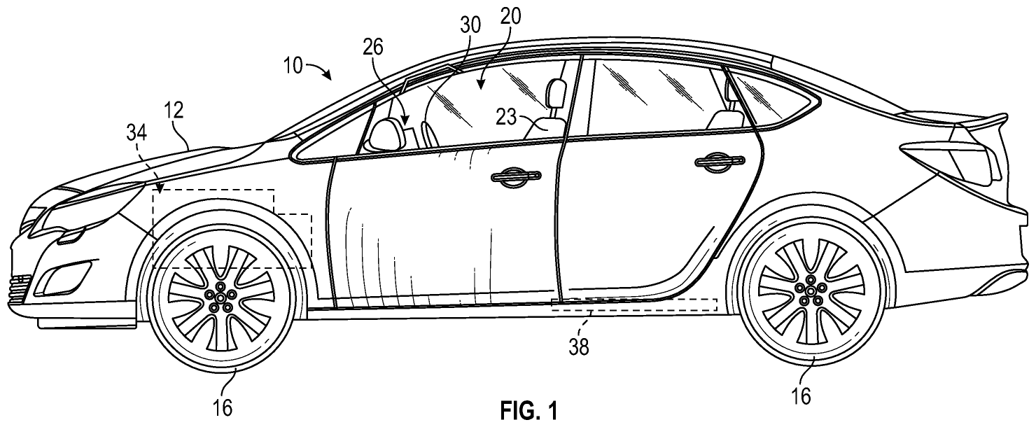

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electric drive unit 34 that provides power to one or more of the plurality of wheels 16.

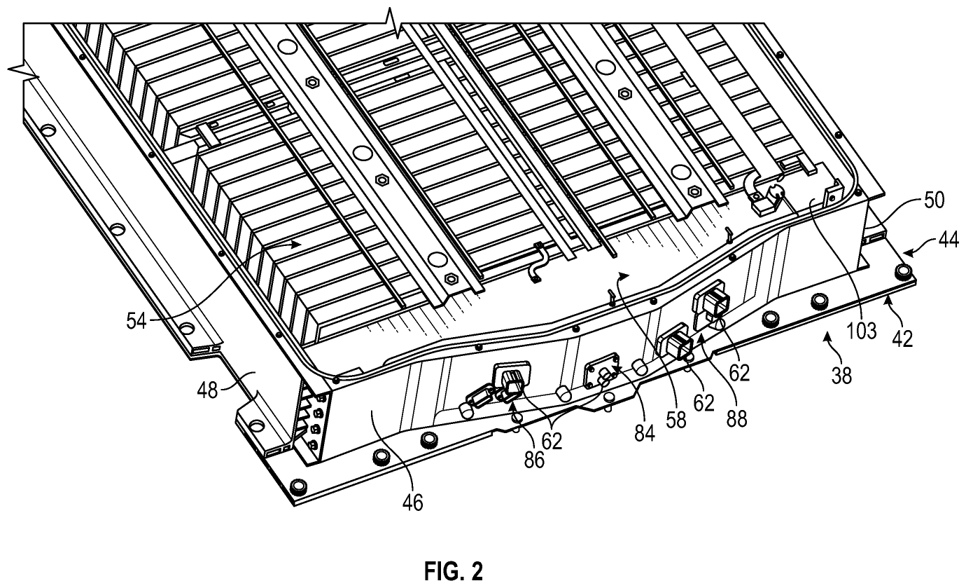

A rechargeable energy storage system (RESS) or battery assembly 38 is arranged in body 12 and provides power to electric drive unit 34. In other arrangements, a fuel cell may be used to provide power to electric drive unit 34. At this point, it should be understood that the location of electric drive unit 34 and battery assembly 38 may vary. In a non-limiting example shown in FIG. 2, RESS 38 includes a housing 42 having a plurality of walls 44. Plurality of walls 44 include at least a first wall 46, a first side wall 48, and a second side wall 50. Housing 42 encloses a plurality of battery cells 54 and a battery disconnect unit (BDU) 58. BDU 58 is arranged between the plurality of battery cells 54 and first wall 46.

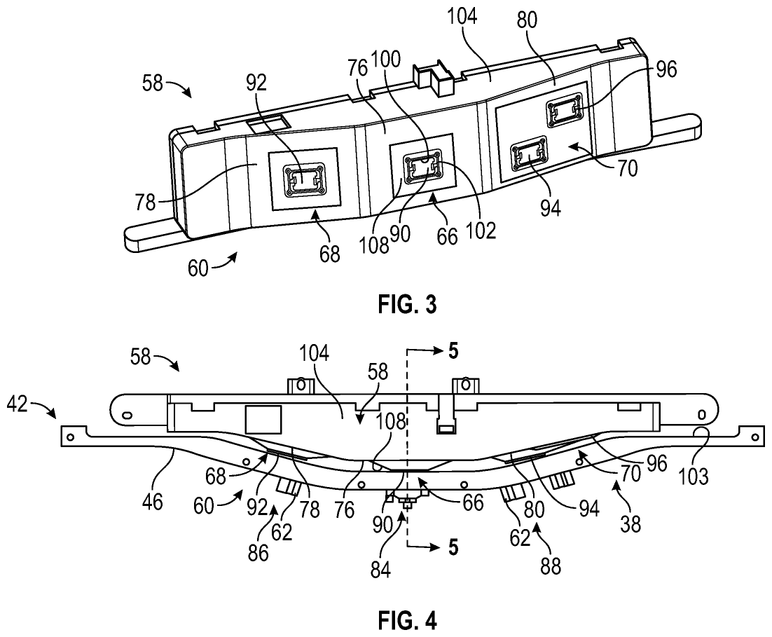

Referring to FIGS. 3 and 4 and with continued reference to FIG. 2, BDU 58 includes a first plurality of electrical connectors 60 and housing 42 includes a second plurality of electrical connectors 62 mounted to first wall 46. BDU 58 serves as an interface between the plurality of battery cells 54 and housing 42. The second plurality of electrical connectors 62 serve as an interface between RESS 38 and vehicle 10. In a non-limiting example, the first plurality of electrical connectors 60 include a first connector member 66, a second connector member 68, and a third connector member 70.

First connector member 66 is defined on a first plane 76, second connector member 68 is defined on a second plane 78, and third connector member 70 is defined on a third plane 80. Second plane 78 and third plane 80 are angled relative to first plane 76 as shown in FIG. 4. Second plurality of electrical connectors 62 include a first connector element 84, a second connector element 86, and a third connector element 88. In a non-limiting example, first connector element 84 is configured to engage with first connector member 66, second connector element 86 is configured to engage with second connector member 68, and third connector member 70 is configured to engage with third connector element 88.

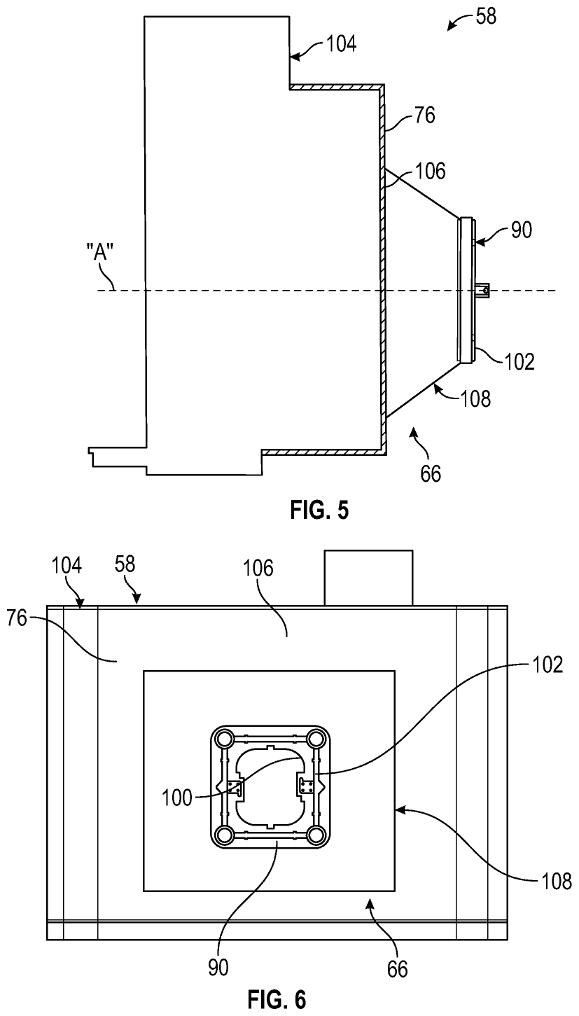

In a non-limiting example, first connector member 66 defines a first socket 90, second connector member 68 defines a second socket 92, and third connector member 70 defines a third socket 94 and a fourth socket 96. Reference will now follow to FIGS. 5 and 6 in describing first connector member 66 with an understanding that second connector member 68 and third connector member 70 include corresponding structure. First connector member 66 includes an opening 100 defining first socket 90. Opening 100 is surrounded by a press-in-place (PIP) seal 102 that engages a back side 103 of first wall 46 when BDU 58 is connected to housing 42. First connector member 66 is mounted to a housing 104 of BDU 58. Housing 104 includes a rigid base 106. First connector member 66 is coupled to rigid base 106 through a resilient connector support 108. Resilient connector support 108 extends from rigid base 106 along a connector axis “A”.

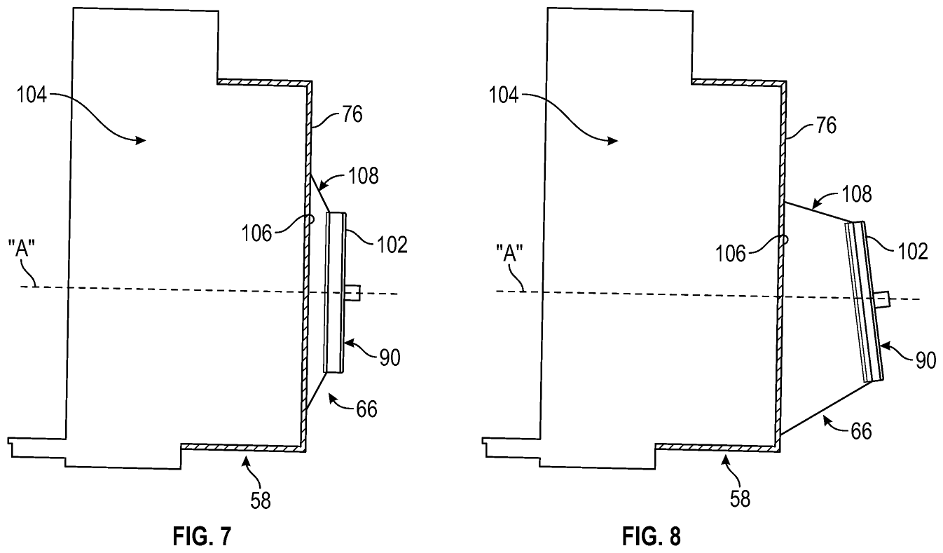

In a non-limiting example, resilient connector support 108 may deform, shift, or otherwise adapt to any misalignments with first connector element 84 in first wall 46 without compromising connection integrity. Resilient connector support 108 is formed from a flexible non-electrically conductive material such as an elastomer, a rubber, silicone, or the like. Resilient connector support 108 provides compliance at an interface with first socket 90 and at an interface with rigid base 106. For example, as shown in FIG. 7, resilient connector support 108 may deflect or shift along connector axis “A” in order to promote a desired alignment between socket 90 and first connector element 84. Resilient connector support 108 may also shift at an angle relative to connector axis “A” as shown in FIG. 8, the particular angle of the shift may vary.

Further, it should be understood that resilient connector support 108 can shift along connector axis “A” and at an angle relative to connector axis “A” to promote alignment and thereby facilitate an easy assembly of RESS 38. At this point, it should be understood that while shown in connection with a BDU 58, the resilient connector support 108 may be used in a variety of applications. Further, it should be understood that through the use of resilient connector support 108 an electrical connection may be established without the need to shift or slide BDU 58 in housing 42. Still further, resilient connector support 108 promotes electrical connectivity without compromising any internal sealing in BDU 58.

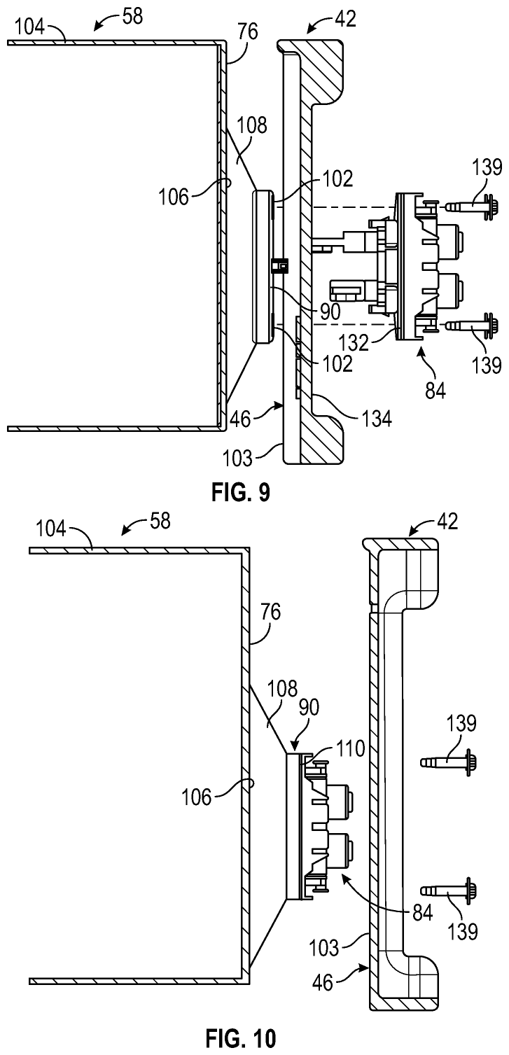

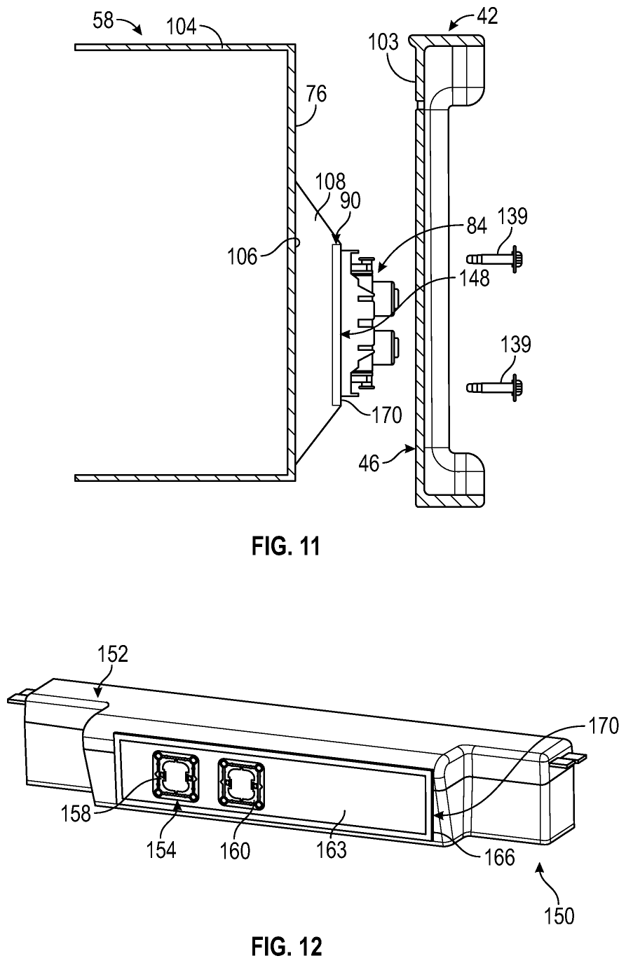

Referring to FIG. 9, first connector element 84 extends through first wall 46 into first socket 90. Resilient connector support 108 may deform to ensure a desired alignment between first connector element 84 and first socket 90. When connected, PIP 102 seals against an inner surface 103 of first wall 46 and another PIP seal 132 on first connector element 84 will seal against an outer surface 134 of first wall 46. Mechanical fasteners 139 may be used to secure housing 42 to BDU 58. Mechanical fasteners 139 may also be used to provide the clamp load necessary to ensure PIP seal 132 and PIP seal 102 are properly compressed to establish a more robust leak-proof system. FIG. 10 shows resilient connector support 108 combined with socket 90 that is provided with a single PIP seal 110. PIP seal 110 engages inner surface 103 of first wall 46 to form a water-tight seal for housing 42. In this arrangement, socket 90 may pass through an opening (not shown) in first wall 46 and be secured through mechanical fasteners 139. In FIG. 11, resilient connector support 108 is over-molded onto socket 90 and, in a non-limiting example, is sufficiently flexible so as to serve as a sealing surface 148 that engages inner surface 103 of housing 42. In the non-limiting example shown, resilient connector support 108 alleviates the need for a PIP seal.

A BDU, in accordance with another non-limiting example, is shown at 150 in FIG. 12. BDU 150 includes a housing 152 supporting a first plurality of electrical connectors 154 including a first connector member 158 and a second connector member 160. First connector member 158 and second connector member 160 are arranged in a common plane and coupled to a rigid connector support 163. That is, housing 152 includes a rigid base 166 to which is coupled rigid connector support 163. Rigid connector support 163 may move independently of rigid base 166 due to the presence of a resilient flexible joint 170. In a manner similar to that discussed herein, resilient flexible joint 170 is formed from a flexible electrically insulative material that is designed to promote a selected alignment between electrical connections to promote an easy assembly of RESS 38 and reduce production costs.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system comprising:
a first member including a first electrical connector; and
a second member including a second electrical connector, wherein the first member includes a rigid base and a resilient connector support coupled to the rigid base, the first electrical connector being mounted to the resilient connector support.

2. The system according to claim 1, wherein the first electrical connector and the second electrical connector define a connection axis, wherein the resilient connector support is selectively shiftable relative to the connection axis when forming an electrical connection.

3. The system according to claim 2, wherein the first electrical connector is shiftable along an axis that is substantially parallel with the connection axis when forming the electrical connection.

4. The system according to claim 2, wherein the first electrical connector is shiftable along an axis that is angled relative to the connection axis when forming the electrical connection.

5. The system according to claim 2, wherein the first electrical connector is shiftable along a first axis and along a second axis when forming the electrical connection.

6. The system according to claim 5, wherein one of the first axis and the second axis is substantially parallel with the connection axis.

7. The system according to claim 1, wherein the resilient connector support is formed from a non-electrically conductive flexible material.

8. The system according to claim 7, wherein the non-electrically conductive flexible material is one of an elastomeric material, a rubber material, a silicone material, and combinations thereof.

9. The system according to claim 1, wherein the first member is a battery disconnect unit and the second member is a battery assembly.

10. The system according to claim 1,
wherein the first electrical connector includes a first connector member arranged in a first plane, a second connector member arranged in a second plane distinct from the first plane, and a third connector member arranged in a third plane, and
wherein the second electrical connector includes a first connector element arranged in the first plane, a second connector element arranged in the second plane, and a third connector element arranged in the third plane.

11. A vehicle comprising:
a body defining a passenger compartment;
a drive unit supported in the body; and
a rechargeable energy storage system (RESS) connected to the drive unit, the RESS including a battery disconnect unit having a first member including a first electrical connector and a battery assembly including a second member including a second electrical connector, wherein the first member includes a rigid base and a resilient connector support coupled to the rigid base, the first electrical connector being mounted to the resilient connector support.

12. The vehicle according to claim 11, wherein the first electrical connector and the second electrical connector define a connection axis, wherein the resilient connector support is selectively shiftable relative to the connection axis when forming an electrical connection.

13. The vehicle according to claim 12, wherein the first electrical connector is shiftable along an axis that is substantially parallel with the connection axis when forming the electrical connection.

14. The vehicle according to claim 12, wherein the first electrical connector is shiftable along an axis that is angled relative to the connection axis when forming the electrical connection.

15. The vehicle according to claim 12, wherein the first electrical connector is shiftable along a first axis and along a second axis when forming the electrical connection.

16. The vehicle according to claim 15, wherein one of the first axis and the second axis is substantially parallel with the connection axis.

17. The vehicle according to claim 11, wherein the resilient connector support is formed from a non-electrically conductive flexible material.

18. The vehicle according to claim 17, wherein the non-electrically conductive flexible material is one of an elastomeric material, a rubber material, a silicone material, and combinations thereof.

19. The vehicle according to claim 11,
wherein the first electrical connector includes a first connector member arranged in a first plane, a second connector member arranged in a second plane distinct from the first plane, and a third connector member arranged in a third plane, and
wherein the second electrical connector includes a first connector element arranged in the first plane, a second connector element arranged in the second plane, and a third connector element arranged in the third plane.

20. The vehicle according to claim 11, wherein the resilient connector support is bonded to the rigid base.
